(19) United States
(12) Patent Application Publication
(10) Pub. No.: US 2019/0126799 A1
(43) Pub. Date: May 2, 2019

(54) VALVE MODULES FOR INFLATABLE SEATS

(71) Applicant: Ford Global Technologies, LLC, Dearborn, MI (US)

(72) Inventors: Jeroen Lem, Maastricht (NL); Brian Boland, Pinckney, MI (US)

(73) Assignee: Ford Global Technologies, LLC

(21) Appl. No.: 15/802,041

(22) Filed: Nov. 2, 2017

(51) Int. Cl. B60N 2/90; B60N 2/70; B60N 2/66; F16K 15/20

(52) U.S. Cl. CPC B60N 2/914; B60N 2/976; F16K 15/207; B60N 2/665; B60N 2/7088

(57) ABSTRACT

A seating assembly includes a seat base. A seatback is operably coupled to the seat base. A plurality of bladders is positioned within at least one of the seatback and the seat base. A fluid pump and a valve module are in fluid communication with the plurality of bladders and the pump includes a common pressure rail and a plurality of two-way valves each in communication with the pressure rail and one of the bladders. A one-way valve is fluidly coupled to each of the two-way valves.

### FIELD OF THE INVENTION

The present disclosure generally relates to vehicle seating assemblies, and more particularly, to inflatable elements and valves for seating assemblies.

### BACKGROUND OF THE INVENTION

Many seats have integrated bladders to control adjustment features or enable massage features. Conventional bladders utilize three-way valves, which may enable the bladders to be inflated and deflated and also enable the ability to keep a pressure in the bladders. Two-way valves may be used to inflate the bladders, but do not allow the holding of pressure and may cause the bladder to deflate. As such, complex control of the bladders may not be realized with the use of two-way valves. Accordingly, new seating assemblies and valve control systems are desirable.

### SUMMARY OF THE INVENTION

According to one aspect of the present disclosure, a seating assembly includes a seat base. A seatback is operably coupled to the seat base. A plurality of bladders is positioned within at least one of the seatback and the seat base. A fluid pump and a valve module are in fluid communication with the plurality of bladders and the pump includes a common pressure rail and a plurality of two-way valves each in communication with the pressure rail and one of the bladders. A one-way valve is fluidly coupled to each of the two-way valves.

According to another aspect of the present disclosure, a vehicle seating assembly includes a seat base. A seatback is operably coupled to the seat base. A plurality of bladders is positioned within at least one of the seatback and the seat base. A valve module is in fluid communication with the plurality of bladders including a common pressure rail. A plurality of valves is in communication with the pressure rail. A check valve is coupled between each of the valves and the pressure rail.

According to yet another aspect of the present disclosure, a vehicle seating assembly includes a seat base. A seatback is operably coupled to the seat base. A plurality of bladders is positioned within at least one of the seatback and the seat base. A valve module is in fluid communication with the plurality of bladders including a common pressure rail. A plurality of valves are each in communication with the pressure rail and one of the bladders and is configured to exhaust fluid in the bladders. A check valve is coupled to each of the valves.

These and other aspects, objects, and features of the present disclosure will be understood and appreciated by those skilled in the art upon studying the following specification, claims, and appended drawings.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

In the drawings:

FIG. 1 is a perspective view of a vehicle, according to at least one example;

FIG. 2A is a front elevational view of a seating assembly, according to at least one example;

FIG. 2B is a front elevational view of a seating assembly, according to at least one example;

FIG. 3A depicts a schematic two-way valve, according to at least one example;

FIG. 3B depicts a schematic valve module, according to at least one example;

FIG. 3C depicts a schematic valve module, according to at least one example;

FIG. 4 is a plot of pressure vs. time, according to at least one example; and

FIG. 5 is a schematic diagram of the vehicle, according to at least one example.

### DETAILED DESCRIPTION OF THE PREFERRED EMBODIMENTS

Additional features and advantages of the invention will be set forth in the detailed description which follows and will be apparent to those skilled in the art from the description, or recognized by practicing the invention as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature, or may be removable or releasable in nature, unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

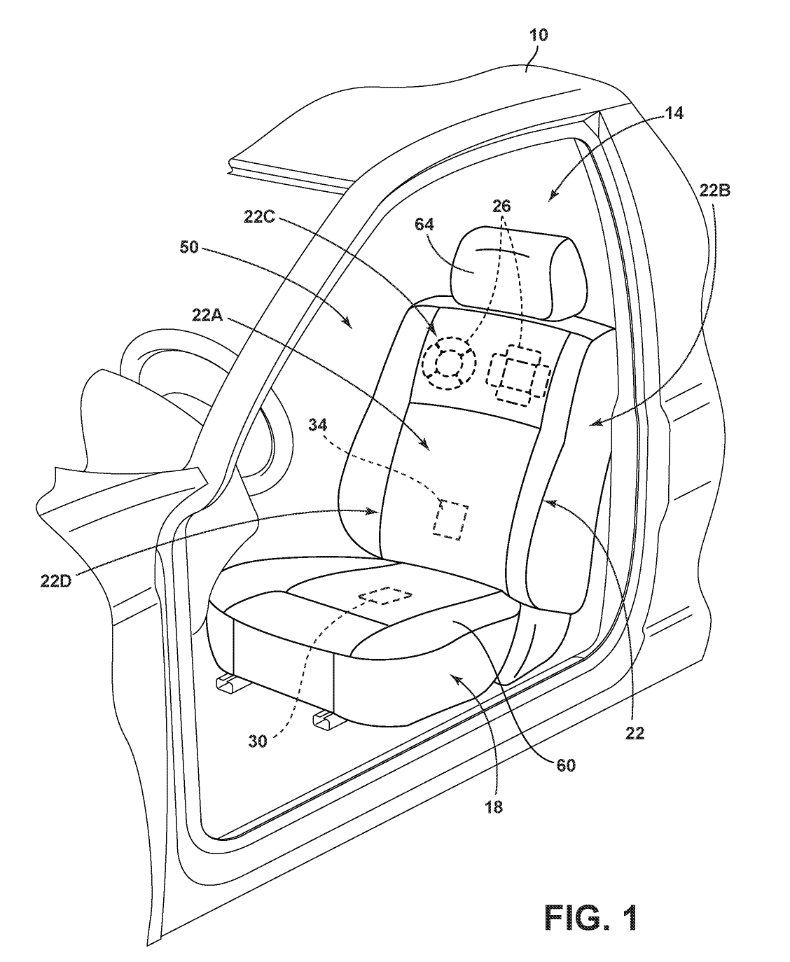

Referring now to FIGS. 1-5, reference numeral 10 generally designates a vehicle. A seating assembly 14 is positioned within the vehicle 10. As such, the seating assembly 14 may be known as a vehicle seating assembly. The seating assembly 14 includes a seat base 18 and a seatback 22 operably coupled to the seat base 18. A plurality of bladders 26 are positioned within at least one of the seatback 22 and the seat base 18. The seating assembly 14 may include a fluid pump 30. A valve module 34 is in fluid communication with the plurality of bladders 26 and the pump 30. The valve module 34 includes a common pressure rail 38 and a plurality of two-way valves 42 each in communication with the pressure rail 38 and one of the bladders 26. A one-way valve 46 is fluidly coupled to each of the two-way valves 42.

Referring now to FIG. 1, the vehicle 10 includes a passenger cabin 50 within which the seating assembly 14 is positioned. The seating assembly 14 may be positioned in a front row or a rear row of seating. In the depicted example, the seat assembly 14 is shown as a bucket seat, but it will be understood that the seat assembly 14 may take a variety of configurations including a bench seat, a stadium seat and/or a jump seat. It will be understood that although depicted within the vehicle 10, the seating assembly 14 may be utilized outside of the vehicle 10 (e.g., in fixed, stationary and/or movable examples) without departing from the teachings provided herein.

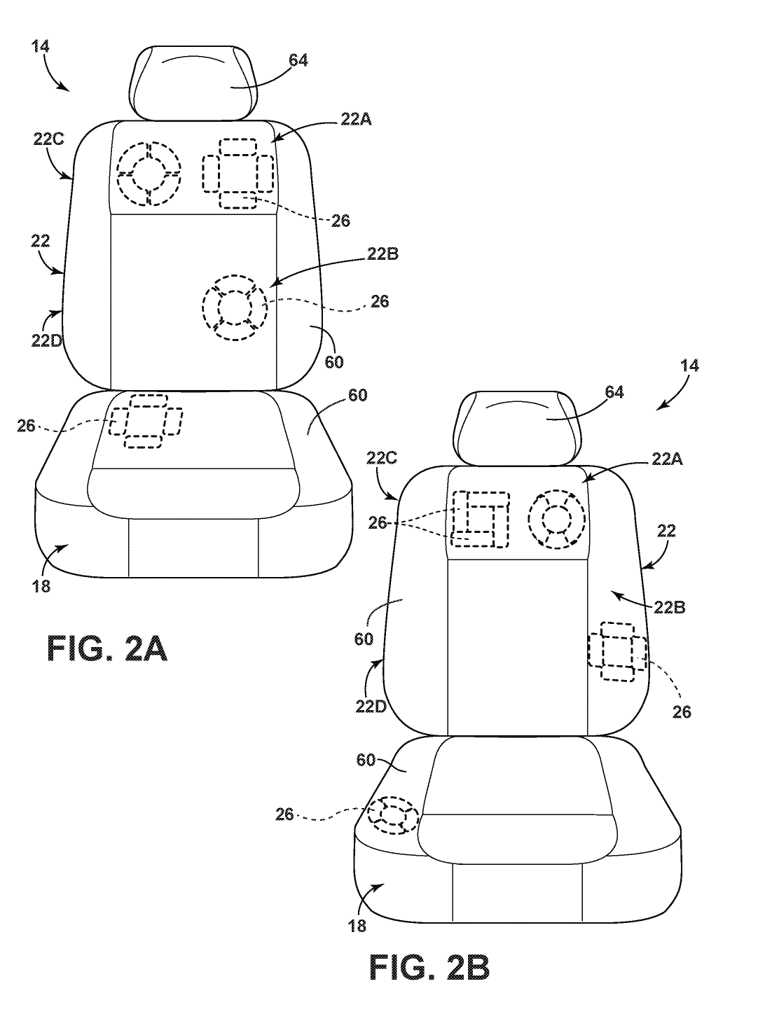

Referring now to FIGS. 1-2B, the seatback 22 of the seating assembly 14 may include a center portion 22A and side bolsters 22B positioned on inboard and outboard sides of the center portion 22A. The seatback 22 may include an upper portion 22C and a lower portion 22D. It will be understood that the seating assembly 14 may include one or more intermediate portions without departing from the teachings provided herein. A trim component 60 is positioned over the seating assembly 14. The trim component 60 may be composed of a polymeric material, a fabric and/or natural material (e.g., leather). The trim component 60 may be stretched across the seatback 22, the seat base 18, the bladders 26 and/or the valve module 34 to provide an aesthetically pleasing look and feel to the seating assembly 14. According to various examples, the trim component 60 may be compressible. It will be understood that the seat base 18 and/or seatback 22 may include one or more other components (e.g., ventilation unit, heating element, springs, comfort carriers and/or massage units) without departing from the teachings provided herein.

Referring now to FIGS. 2A-2B, the bladders 26 may be a component of or the entirety of massage elements configured to apply pressure to an occupant positioned within the seating assembly 14. The bladders 26 may be configured to apply pressure in a variety of patterns including linear, wave, random and/or rotational. The bladders 26 may be positioned within the seatback 22 and/or the seat base 18 between a substrate and/or a frame of the seatback 22 and the trim component 60. Further, the bladders 26 may be positioned within a headrest 64 and/or armrest of the seating assembly 14. As such, the bladders 26 may be held in place by the substrate and/or a frame to exert pressure through the trim component 60 and into the occupant of the seating assembly 14.

Although shown and described in connection with a plurality of bladders 26, it will be understood that the seating assembly 14 may include a single bladder 26 or more than two bladders 26. For example, the seating assembly 14 may include upwards of 10, 20, 30, 40 or 50 bladders 26 positioned in and/or around the seating assembly 14. The bladders 26 may be positioned within the center portion 22A of the seatback 22, the upper portion 22C, lower portion 22D, the side bolsters 22B and/or anywhere in the seat base 18 of the seating assembly 14. For example, the seating assembly 14 may include bladders 26 in the bolsters and the center portions of both or one of the seat base 18 and seatback 22.

The bladders 26 may be discrete from one another or may be components of a larger array or pattern of bladders 26. For purposes of this disclosure, discrete may mean a standalone structure which is not a subpart of another structure. Further, although the bladders 26 may be discrete from one another, the bladders 26 may work in conjunction with one another. For example, an activation pattern of one of the bladders 26 may be mirrored and/or performed in a complementary manner by other bladders 26. For purposes of this disclosure, an array of bladders 26 may be an organized (e.g., a repeating structure) or a disorganized (e.g., non-repeating or random) plurality of bladders 26 configured to be operated together (e.g., simultaneously and/or sequentially).

According to various examples, the bladders 26 may be arranged in a substantially circular orientation, or array. It will be understood that the bladders 26 may take a variety of configurations such as oblong, triangular, square, rectangular and higher order polygons without departing from the teachings provided herein. In circular orientations of an array of bladders 26, at least one of the bladders 26 may have a substantially arc shape and/or is semi-circular. In arc shaped or semi-circular shaped examples of the bladders 26, the bladders 26 may have a first (e.g., inner) radius and a second (e.g., outer) radius with the outer radius being greater than the inner radius. The bladders 26 may be positioned next to one another, proximate one another, in contact and/or in an overlapping (FIG. 2B) manner. In overlapping examples of the bladders 26, the bladders 26 may have an overlapping area of greater than or equal to about 1%, 5%, 10%, 20%, 30%, 40%, 50%, 60%, 70%, 80%, 90% or greater than or equal to about 99%. According to various examples, at least two of the bladders 26 are at least partially overlapping. For example, two, three, four and/or all of the bladders 26 may overlap another bladder 26 to some degree. Further, it will be understood that different arrays of the bladders 26 may overlap to some degree.

The bladders 26 are operable between inflated and deflated states. Each of the bladders 26 may be independently inflatable and/or two or more bladders 26 may be linked (e.g., through fluid coupling or through a controller) to inflate together. The bladders 26 may be composed of a polymeric and/or elastomeric liner 26A. The liner 26A may be fluid-tight such that fluids may not permeate across the liner 26A of the bladder 26. According to various examples, the liner 26A may be configured to expand, or stretch, when inflated such that the bladders 26 may increase in size in the inflated state relative the deflated state. The liner 26A of the bladder 26 defines a bladder cavity within which a fluid (e.g., gas and/or liquid) may be stored. Exemplary fluids which may transition the bladders 26 between the inflated and deflated states may include water, oil, air, gasses and/or other fluids which may enter and exit the bladders 26. It will be understood that the fluid entering and exiting the bladders 26 may be heated and/or cooled. The fluid may be moved in and out of the bladders 26 through use of the fluid pump 30, a compressor and/or a tank (e.g., a reservoir). A single pump 30 may be used for all of the bladders 26 or one or more of the bladders 26 may be coupled to separate pumps 30. Fluid pressure within the bladder cavity of the bladder 26 may inflate the bladder 26 to a predetermined size and provide bladder 26 with a predetermined, or designed, resiliency. In the inflated state, the bladders 26 may contact the trim component 60 and press against an occupant of the seating assembly 14. Increasing the fluid pressure within the bladders 26 may result in the bladder 26 pressing deeper into the occupant as well as being less resilient (i.e., give a harder feeling to the bladder 26). In the inflated state, the bladders 26 may aid in providing a desired support or design to the seating assembly 14. Further, coordinated inflation of the bladders 26 may aid in providing a massaging effect to an occupant of the seating assembly 14 as explained in greater detail below.

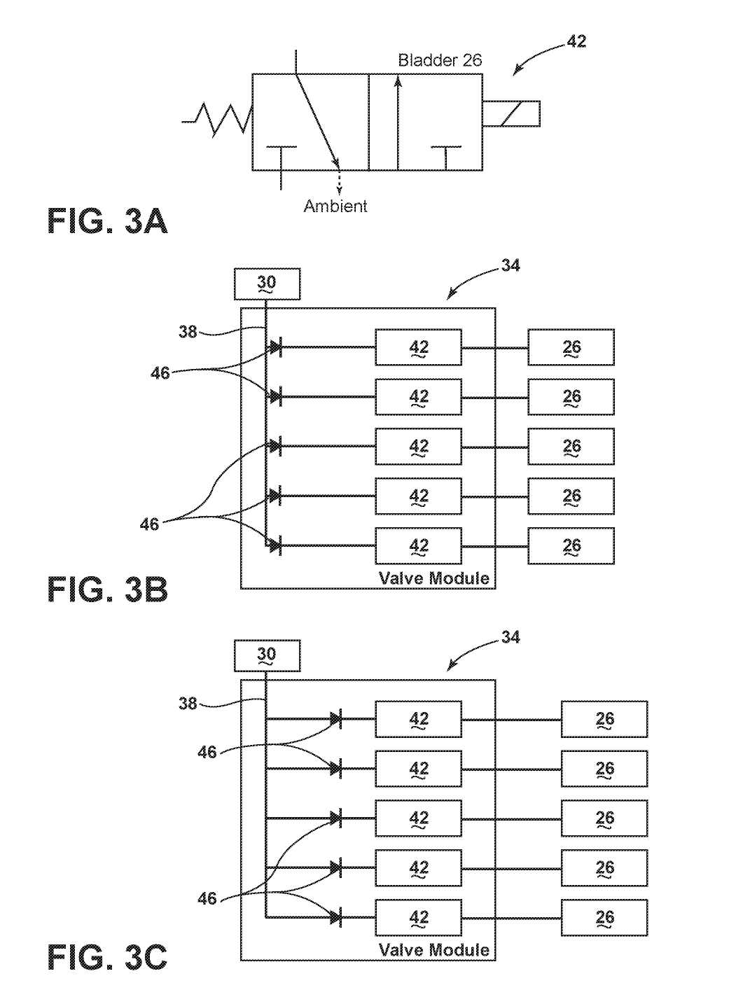

Referring now to FIGS. 3A-3C, the vehicle 10 and/or seating assembly 14 includes the valve module 34. The valve module 34 may be positioned within the seating assembly 14, or may be positioned elsewhere within the vehicle 10. For example, the valve module 34 may be positioned in a floor or trim component proximate the seating assembly 14. Further, the seating assembly 14 and/or vehicle 10 may include more than one valve module 34. For example, each seating assembly 14 of the vehicle 10 may have a dedicated valve module 34. Although the components of the valve module 34 are depicted as grouped, or proximate one another, it will be understood that the components of the valve module 34 may be spread apart across the seating assembly 14. For example, the two-way valves 42 may be spread across the seating assembly 14 such that the two-way valves 42 are positioned proximate the bladders 26 while the common pressure rail 38 is positioned at a base of the seating assembly 14. As explained in greater detail below, the valve module 34 is configured to regulate the fluid pressure within the bladders 26 and/or to selectively inflate and deflate the bladders 26. Such a feature may be advantageous in facilitating a complex (e.g., rotational massage, wave massage, etc.) activation of the bladders 26.

The valve module 34 includes the common pressure rail 38, the two-way valves 42, and the plurality of one-way valves 46. The common pressure rail 38 is fluidly coupled with the pump 30 and configured to receive pressurized fluid therefrom. Further, it will be understood that one or more reservoirs may be positioned between the pump 30 and the pressure rail 38. The common pressure rail 38 is further fluidly coupled with the one-way valves 46, the two-way valves 42 and the bladders 26. The common pressure rail 38 is configured to distribute fluid to the one- and two-way valves 46, 42 and into the bladders 26. As such, the common pressure rail 38 may be known as a distribution rail or accumulator. The common pressure rail 38 may have a uniform diameter (e.g., one or both on an internal and external diameter), or may have a diameter which varies across its length. Further, the valve module 34 may include one or more pressure sensors positioned along the length of the common pressure rail 38 to sample the fluid pressure and/or flow rate supplied to each of the bladders 26.

The two-way valves 42 are positioned between the common pressure rail 38 and the bladders 26. As such, the two-way valves 42 fluidly couple the common pressure rail 38 to the bladders 26. A schematic example of the two-way valves 42 is depicted in FIG. 3A. Such an example of the two-way valves 42 may also be known as a three/two-valve. The two-way valves 42 may be control valves having an inlet and an outlet port. Each of the two-way valves 42 may be operated between two states. In a first state, the two-way valves 42 may be configured to allow fluid to pass between the common pressure rail 38 and the bladder 26. In a second state, the two-way valves 42 may be configured to exhaust fluid from the bladder 26 through the two-way valves 42 into the ambient environment. The two-way valves 42 allow for fluid pressure applied to the bladders 26 to be turned on and off (e.g., allowing fluid to move across the two-way valve 42 or to be exhausted through the two-way valve 42). Further, the two-way valves 42 may allow for a variable flow rate of fluid to be applied to the bladders 26. The two-way valves 42 may allow the flow of fluid to travel in two ways. For example, fluid may flow to or from the bladders 26. In such an example, the two-way valves 42 may allow fluid to move from the common pressure rail 38 to the bladders 42, 26 and to be exhausted out of the two-way valve 42. The two-way valves 42 allow flow in the valve module 34 in two directions, but at a certain pressure differential. The pressure differential can be the same in both directions, but also different. For example at a low pressure in one direction and a high pressure in an opposite direction. The two-way valves 46 may be composed of plastic and/or metal. For example, the two-way valves 42 may be a solenoid, but may also include a shape memory alloy and/or a piezoelectric material.

The one-way valves 46 may be positioned proximate the common pressure rail 38 (e.g., FIG. 3B) and/or the inlet of the two-way valves 42 (e.g., FIG. 3C). In some examples, at least one of the one-way valves 46 is positioned proximate the inlet of the two-way valves 42, while in other examples a plurality of the one-way valves 46 are positioned proximate the inlet of the two-way valves 42. In yet other examples, the one-way valves 46 may be positioned along the common pressure rail 38 upstream of distribution lines to each of the bladders 26. For example, a plurality of one-way valves 46 may be positioned along the common pressure rail 38 with one or more one-way valves 46 positioned between the bladders 26. In other words, one or more one-way valves 46 may be positioned along the common pressure rail 38 between each of the inlets of the bladders 26. Use of this example may allow the same benefits and allow for an easier implementation of the common pressure rail 38.

The one-way valves 46 may be known as a check valve, clack valve, non-return valve and/or a reflux valve. The one-way valve 46 is a valve that normally allows fluid to flow through it in only one direction. The one-way valves 46 are two-port valves, meaning they have two openings in a body, one for fluid to enter and the other for fluid to leave. The one-way valves 46 may work automatically and may not be controlled by a person or any external control (e.g., electronically). In yet other examples, the one-way valves 46 may be controlled by a controller. The bodies of the one-way valves 46 may be composed of plastic and/or metal. The one-way valves 46 may have a cracking pressure, a reseal pressure and a back pressure. The cracking pressure is the inlet pressure at which the first indication of flow occurs. The cracking pressure may also be known as unseating head (pressure). The reseal pressure may be the pressure at which there is no indication of flow. Reseal pressure may also be known as a sealing pressure or seating head (pressure). The back pressure may be the differential pressure between the inlet and outlet pressures.

Referring now to FIGS. 3A-5, use of the one-way valves 46 may allow for the selective inflation of one or more of the bladders 26 without the back pressurizing of other bladders 26. In operation, the one-way valves 46 hinder the backflow of fluid from the bladders 26 into the common rail 38 and/or other bladders 26. In conventional designs, check valves may be utilized at the entrance to a valve pack to prevent pressure from back flowing to a pump or reservoir; however, such systems have the drawback that only a single bladder at a time can be controlled. Use of the valve module 34 utilizing the one-way valves 46 allows for selective inflation and deflation of the bladders 26 while the two-way valves 42 are open and allowing fluid to move. For example, a first bladder 26 may be raised from an atmospheric pressure to a target pressure, held for a predetermined amount of time (e.g., by preventing the back flow of fluid using the one-way valves 46 while the two-way valves 42 are open) and after being held for a predetermined period of time the pressure is released back to atmospheric pressure (e.g., by venting the fluid from the bladder 26 to the ambient environment through the two-way valves 42). A second bladder 26 may begin to be inflated once the first bladder 26 reaches the target pressure and once the second bladder 26 reaches the target pressure it may be held for a predetermined period of time before the pressure is released. Use of the one-way valves 46 allows for the pressure of the first bladder 26 to remain constant while the second bladder 26 is filling by preventing back flow from the first bladder 26 into the second bladder 26.

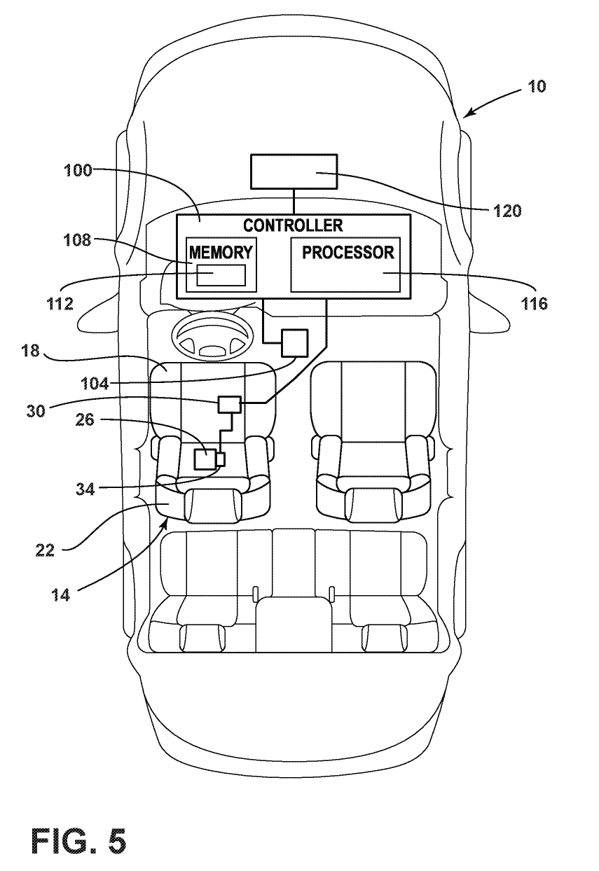

Referring now to FIG. 5, the two-way valves 42 may be actuated between open and exhaust states based on a signal from a controller 100. For example, the controller 100 may actuate the two-way valves 42 which engages a massage motion of the seat assembly 14 by selectively inflating and deflating the bladders 26. In the open position, the two-way valves 42 may allow the bladders 26 to intake fluid to allow the bladder 26 to transition to the inflated state. The one-way valve 46 may hold pressure within the bladder 26 while the two-way valve 42 is in the open state. The one-way valve 46 may seal the bladder 26 such that the bladder 26 provides resiliency and does not compress under a weight from the occupant of the seating assembly 14. The two-way valve 42 is then transitioned to the exhaust state to vent the fluid in the bladder 26 and remove the resiliency of the bladder 26. It will be understood that additional two-way valves 42 may be positioned downstream of the bladders 26 to control deflation of the bladders 26 without departing from the teachings provided herein. Further, additional three-way valves may be utilized to control additional bladder 26 and seat functionality without departing from the teachings provided herein.

The vehicle 10 includes the controller 100 which may be in communication with one or more seat control panels 104. The seat control panel 104 may be configured to allow the occupant of the seating assembly 14 to control various conditions of the seating assembly 14. The controller 100 may include a memory 108 having a massage control routine 112 contained therein that is executed by a processor 116 of the controller 100. The controller 100 may provide electrical power to the pump 30 via a power source 120 located onboard the vehicle 10. The massage control routine 112 may be configured to control a variety of aspects of the seating assembly 14.

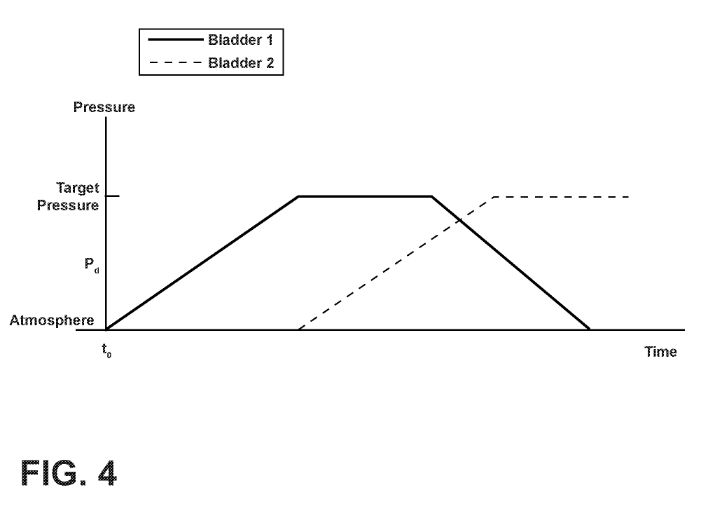

In a first example, the occupant of the seating assembly 14 may activate the massage control routine 112 in a rotational massage state. In such an example, the massage control routine 112 may activate the pump 30 and the two-way valves 42 to sequentially inflate and deflate the bladders 26 in a rotational manner. As such, the plurality of bladders 26 is configured to inflate and deflate in a circular, or square direction. Sequential activation of the bladders 26 may mean that each bladder 26 is fully inflated and fully deflated prior to inflation of the next bladder 26. As such, the plurality of bladders 26 are configured to be inflated and deflated sequentially. Additionally or alternatively, the bladders 26 may be activated in a wave pattern (e.g., FIG. 4) in which more than one bladder 26 is inflated and/or deflated at a time to simulate the feeling of a continuous wave moving in a circular manner. The rotational movement may be simulated to move in a clockwise and/or counterclockwise direction. The pressure applied by the bladders 26 to the occupant of the seating assembly 14 may be adjusted by the occupant through the control panel 104. The speed of the simulated rotation by the bladders 26 may be increased or decreased based on user preference. A heating or cooling of the bladders 26 by the fluid may be adjusted by the occupant. The rotations per minute may be altered by the occupant. It will be understood that other bladders 26 in other activation operations (e.g., wave motions, seat adjustments, etc.) may simultaneously be activated.

In a second example, the bladders 26 may provide a kneading and/or a knocking motion to the occupant. For example, quick inflation and deflation of the bladders 26 may provide a quick concussive force which an occupant of the seating assembly 14 may find pleasurable.

In a third example, the bladders 26 may be controlled to provide various aesthetic and functional properties to the seating assembly 14. For example, the control panel 104 may control the inflation and/or deflation of the bladders 26 to provide a particular appearance (e.g., a racing styling and/or a low profile styling) to the seating assembly 14. Additionally or alternatively, the control panel 104 may be used to control the adjustment of the seating assembly 14 based on the occupant of the seating assembly 14. For example, the bladders 26 may be inflated to adjust for differences in width, height, H-point and/or other physical attributes of the occupant to increase comfort and/or safety of the occupant in the seating assembly 14.

Use of the present disclosure may offer a variety of advantages. First, the presently disclosed bladders 26 and valve module 34 allow for the pleasurable massaging effect to occupants of the seating assembly 14. Second, use of the one-way valves 46 allow for two-way valves 42 to be used as opposed to relatively more expensive and conventional three-way valves. In addition to a cost savings of using the two-way valves 42, the two-way valves 42 may be lighter than three-way valves which may lead to a decreased weight of the seating assembly 14. A lighter seating assembly 14 may increase the fuel economy of the vehicle 10. Third, as the bladders 26 may be used to adjust the fit of the occupant to the seating assembly 14, the bladders 26 and/or valve module 34 may be used to increase comfort and/or safety of the occupant within the seating assembly 14.

According to various embodiments, a seating assembly includes a seat base, a seatback operably coupled to the seat base, a plurality of bladders positioned within at least one of the seatback and the seat base, a fluid pump and a valve module in fluid communication with the plurality of bladders and the pump. The valve module includes a common pressure rail and a plurality of two-way valves each in communication with the pressure rail and one of the bladders. A one-way valve is fluidly coupled to each of the two-way valves. Embodiments of the seating assembly can include any one or a combination of the following features:
the fluid pump is configured to pump a gas;
the fluid pump is configured to pump a liquid;
the plurality of bladders are configured to be inflated and deflated sequentially;
the bladders are independently inflatable;
at least one of the plurality of bladders is positioned in an upper portion of the seatback;
at least one of the plurality of bladders is positioned in a lower portion of the seatback;
at least one of the one-way valves is positioned proximate an inlet of the two-way valves;
a plurality of the one-way valves is proximate an inlet side of the two-way valves;
at least one of the one-way valves is positioned proximate the common pressure rail; and/or
a plurality of the one-way valves is positioned proximate the common pressure rail.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

What is claimed is:

1. A seating assembly, comprising:
a seat base;
a seatback operably coupled to the seat base;
a plurality of bladders positioned within at least one of the seatback and the seat base;
a fluid pump; and
a valve module in fluid communication with the plurality of bladders and the pump, comprising:
a common pressure rail; and
a plurality of two-way valves each in communication with the pressure rail and one of the bladders, wherein a one-way valve is fluidly coupled to each of the two-way valves.

2. The seating assembly of claim 1, wherein at least one of the one-way valves is positioned proximate an inlet of the two-way valves.

3. The seating assembly of claim 1, wherein a plurality of the one-way valves is proximate an inlet side of the two-way valves.

4. The seating assembly of claim 1, wherein at least one of the one-way valves is positioned proximate the common pressure rail.

5. The seating assembly of claim 4, wherein a plurality of the one-way valves is positioned proximate the common pressure rail.

6. The seating assembly of claim 1, wherein the fluid pump is configured to pump a gas.

7. The seating assembly of claim 1, wherein the fluid pump is configured to pump a liquid.

8. A vehicle seating assembly, comprising:
a seat base;
a seatback operably coupled to the seat base;
a plurality of bladders positioned within at least one of the seatback and the seat base; and
a valve module in fluid communication with the plurality of bladders comprising:
a common pressure rail; and
a plurality of valves in communication with the pressure rail, wherein a check valve is coupled between each of the valves and the pressure rail.

9. The vehicle seating assembly of claim 8, wherein each of the plurality of valves is fluidly coupled with a bladder.

10. The vehicle seating assembly of claim 8, further comprising:
a fluid pump fluidly coupled with the valve module.

11. The vehicle seating assembly of claim 10, wherein the fluid pump is configured to pump a gas.

12. The vehicle seating assembly of claim 8, wherein at least one of the plurality of valves comprises a two-way valve.

13. The vehicle seating assembly of claim 11, wherein the bladders are independently inflatable.

14. A vehicle seating assembly, comprising:
a seat base;
a seatback operably coupled to the seat base;
a plurality of bladders positioned within at least one of the seatback and the seat base; and
a valve module in fluid communication with the plurality of bladders comprising:
a common pressure rail; and
a plurality of valves each in communication with the pressure rail and one of the bladders and configured to exhaust fluid in the bladders, wherein a check valve is coupled to each of the valves.

15. The vehicle seating assembly of claim 14, wherein at least one of the plurality of valves is a two-way valve.

16. The vehicle seating assembly of claim 15, wherein the check valve is a one-way valve.

17. The vehicle seating assembly of claim 16, wherein the plurality of bladders is configured to be inflated and deflated sequentially.

18. The vehicle seating assembly of claim 16, wherein the bladders are independently inflatable.

19. The vehicle seating assembly of claim 14, wherein at least one of the plurality of bladders is positioned in an upper portion of the seatback.

20. The vehicle seating assembly of claim 14, wherein at least one of the plurality of bladders is positioned in a lower portion of the seatback.
